(19) United States
(12) Patent Application Publication
(10) Pub. No.: US 2025/0106896 A1
(43) Pub. Date: Mar. 27, 2025

(54) MEASUREMENT GAP IN MULTI-RADIO DUAL CONNECTIVITY

(71) Applicant: ZTE Corporation, Shenzhen (CN)

(72) Inventors: Mengjie ZHANG, Shenzhen (CN); Jing LIU, Shenzhen (CN); Jianxun AI, Shenzhen (CN)

(73) Assignee: ZTE Corporation, Shenzhen (CN)

(21) Appl. No.: 18/974,189

(22) Filed: Dec. 9, 2024

Related U.S. Application Data
(63) Continuation of application No. PCT/CN2023/073785, filed on Jan. 30, 2023.

(51) Int. Cl. H04W 74/0816; H04W 24/02; H04W 74/08

(52) U.S. Cl. CPC H04W 74/0816; H04W 24/02; H04W 74/0875

(57) ABSTRACT

Wireless communications when there is a master node (MN) and a secondary node (SN) may be modified to coordinate communication for measurement gaps. Specifically, for dual connectivity in multi-radio (MR-DC), the MN and SN may communicate to improve measurement gap usage. The communications may include gap combination assistance information, a gap configuration based on the gap combination assistance information, and gap association. The embodiments include communication examples for handling the measurement gap with communications between MN and SN.

### TECHNICAL FIELD

This document is directed generally to wireless communications. More specifically, in a mobile device communications system, there may be improved communications for measurement gaps.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for wireless communications in which there is a master node (MN) and a secondary node (SN) may be modified to coordinate communication for measurement gaps. Specifically, for dual connectivity in multi-radio (MR-DC), the MN and SN may communicate to improve measurement gap usage. The communications may include gap or gap combination assistance information, a gap configuration based on the gap or gap combination assistance information, and gap association. The embodiments include communication examples for handling the measurement gap with communications between MN and SN.

In one embodiment, a method for wireless communication includes receiving a gap assistance information; generating gap related configuration based on the received gap assistance information; and transmitting the gap related configuration. The receiving, generating, and transmitting are from a secondary node (SN). The receiving at the SN is from a master node (MN) and the transmitting from the SN is to the MN. The receiving, generating, and transmitting are from a master node (MN). The receiving at the MN is from a secondary node (SN) and the transmitting from the MN is to the SN. The gap related configuration comprises at least one of a gap pattern configuration, a gap identification (ID) information, or a gap association information. A gap from the gap assistance information is a period that a user equipment (UE) uses to perform measurements or operations with a dedicated use case. The gap assistance information comprises at least one of a requested or allowed gap type, a requested or allowed gap purpose, a requested or allowed gap pattern, a requested or allowed number of gap patterns, a requested or allowed gap combination information, a gap identification (ID), a gap ID range, or a gap priority information. The gap type comprises at least one of the following: a concurrent gap, a pre-configured gap, or a network controlled small gap (NCSG). The gap purpose or gap pattern comprises at least one of the following: a per frequency range (FR) 1 gap, a per FR2 gap or a per UE gap. The requested or allowed gap combination information comprises at least one of the following: a bit string or a bitmap, each position in the bit string or the bitmap indicates whether the corresponding gap combination is requested or not, or at least one gap combination index. The gap association information comprises at least one of the following: one or a list of measurement gap being associated with a measurement object or a measurement frequency, or one or a list of measurement gap being associated with a dedicated use case. The gap assistance information comprises an indication configured to indicate whether a pre-configured gap is requested or allowed, or which type of pre-configured gap mechanism is to be used.

In another embodiment, a method for wireless communication includes receiving a gap association information; and updating a measurement configuration based on the received gap association information. The gap association information is for at least one of the following: a measurement gap being associated with a measurement object or a measurement frequency, or a measurement gap being associated with a dedicated use case. The gap association information is for a use case comprising at least one of the following: Positioning Reference Signaling (PRS) measurement, Multi-Universal Subscriber Identity Module (MUSIM) operation, Non-Terrestrial Network (NTN) measurement, Synchronization Signal Block (SSB) measurement, Channel State Information Reference Signaling (CSI-RS) measurement, or E-UTRAN measurement. The gap association information comprises one or a list of gap ID, each gap ID links with a list of SSB or CSI-RS frequencies to be associated with a measurement gap, or each gap ID links with a dedicated use case. The receiving and updating are from a secondary node (SN). The receiving at the SN is from a master node (MN). The gap association information is for SN configured frequencies, and the updating comprises the SN updating a measurement object configuration to associate a measurement object with a measurement gap. The receiving, and updating are from a master node (MN). The receiving at the MN is from a secondary node (SN). The gap association information is for MN configured frequencies, and the updating comprises the MN updating a measurement object configuration to associate a measurement object with a measurement gap.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a network architecture of a basestation Central Unit (CU) and basestation Distributed Unit (DU).

FIG. 4 shows a network architecture with a master node (MN) and a secondary node (SN).

FIG. 5 shows an example of a process with a concurrent gap embodiment.

FIG. 6 shows one embodiment of communications between a master node (MN) and a secondary node (SN).

FIG. 7 shows another embodiment of communications between a master node (MN) and a secondary node (SN).

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

There may be a master node (“MN”) and one or more secondary nodes (“SN”). The MN may include a master cell group (“MCG”) and the SN may each include a secondary cell group (“SCG”). The MCG is the group of cells provided by the master node (“MN”) and the SCG is the group of cells provided by the secondary node (“SN”). The MCG may include a primary cell (“PCell”) and one or more secondary cells (“SCell”). The SCG may include a primary secondary cell (“PSCell”) and one or more secondary cells (“SCell”). Each primary cell may be connected with multiple secondary cells. The primary cells (PCell, PSCell) are the master cells of their respective groups (MCG, SCG, respectively) and may initiate initial access. The primary cells may be used for signaling and may be referred to as special cell (“spCell”) where spCell=PCell+PSCell. The mobility between cells described in these embodiments may be based on the PCell, PSCell, and/or SCell. However, as described, they may be referred to as a source cell and a target cell. A user equipment (“UE”) device may move between nodes or cells in which case a handover or a change/addition operation may occur to improve network reliability for the UE as it moves from a source cell to a target cell.

The UE in the wireless network may operate in Dual Connectivity (DC), including intra-E-UTRA DC or Multi-Radio DC (MR-DC). In the example of intra-E-UTRA DC, both the MN and SN provide E-UTRA access. In the example of MR-DC, one node provides new radio (NR) access and the other provides either E-UTRA or NR access. When operating in DC, a Radio Bearer (RB) can be configured to utilize either the MCG resources (MCG bearer) or SCG resources (SCG bearer) or both (split bearer).

In an MR-DC environment, the master node (MN) may coordinate measurement gap information with the secondary node (SN). The measurement gap information allows the SN to configure and use the measurement gap. The may include setting up the gap association between the measurement gap and the measurement object configured by the SN. Some coordination procedures for measurement gap information may be required between the MN and the SN, such as the Xn/X2 interface.

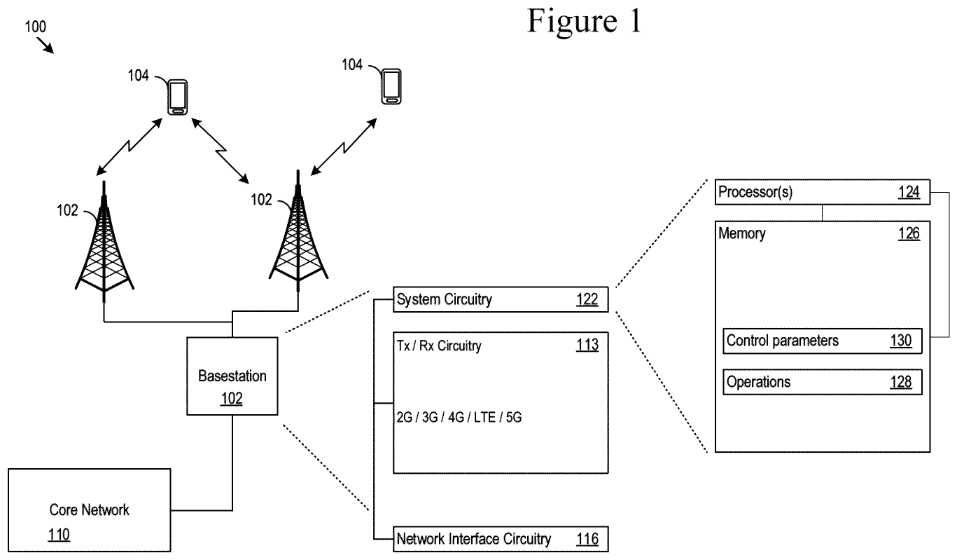

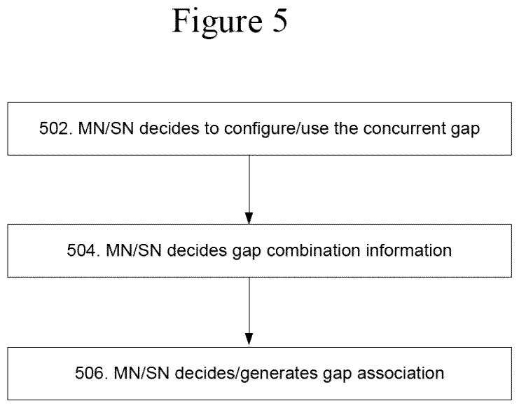

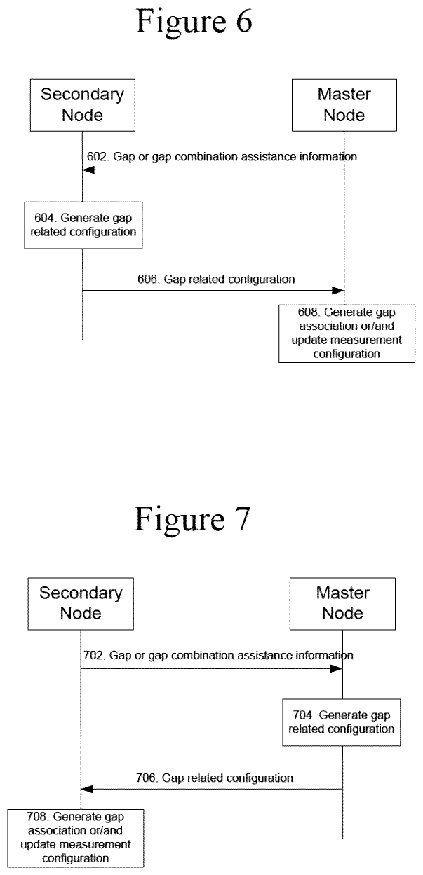

As described below with respect to FIGS. 1-4, a network provider may include a number of network nodes (i.e. basestations) for providing network access to a user equipment (“UE”) device. The network nodes are referred to as basestations in some embodiments. FIG. 5 illustrates a communication process and FIGS. 6-7 illustrate examples for the MR-DC communications for the gap measurement.

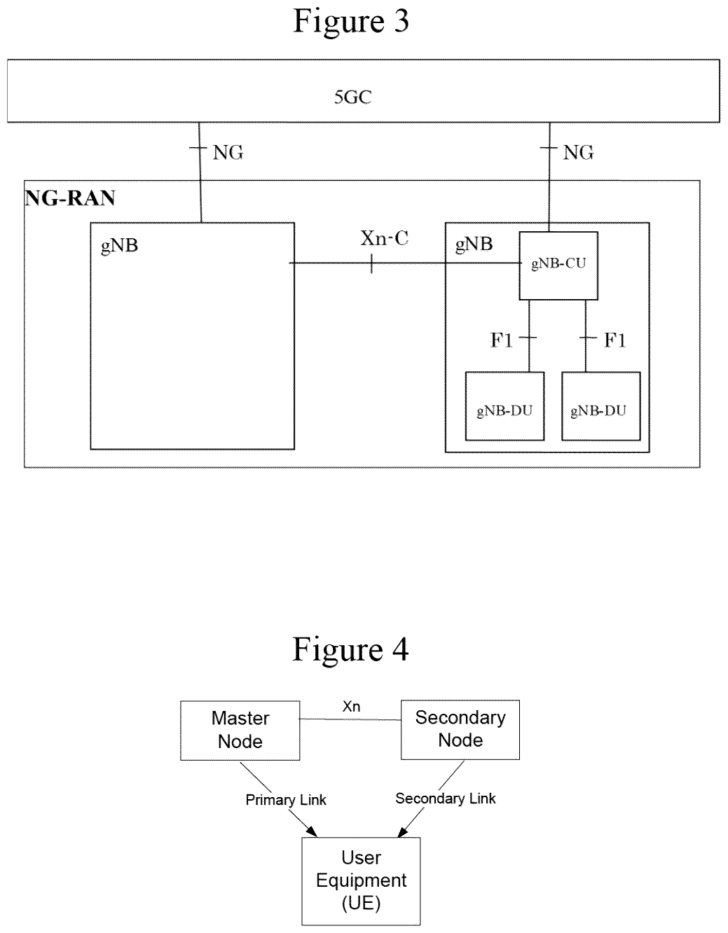

FIG. 1 shows an example basestation 102. The basestation may also be referred to as a wireless network node and may be the network nodes (e.g. master node (“MN”), secondary node (“SN”), and the source/target nodes) shown in FIGS. 3A-7B. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

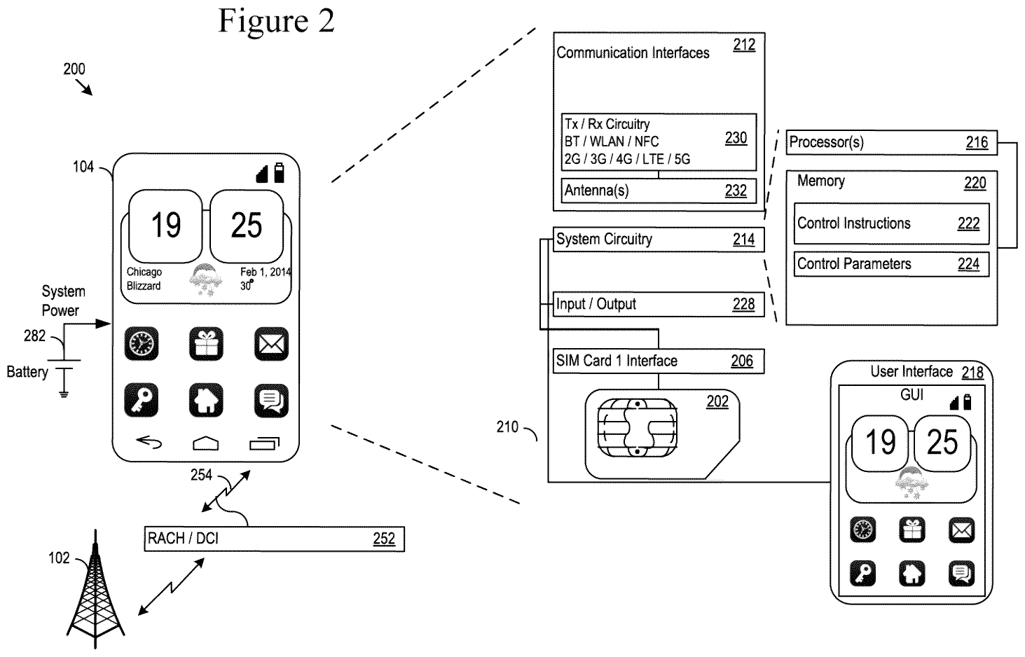

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U (MN) interface instance.

FIG. 3 shows a network architecture of a basestation Central Unit (CU) and basestation Distributed Unit (DU). FIG. 3 illustrates basestations (labeled as “gNB”) that communicate with an overall network (labeled (“5GC”). Basestations can communicate with one another via a control plane interface (“Xn-C”). One basestation is shown as have one CU that is connected to two DUs via an F1 interface. This is merely one example of an arrangement of a basestation. As described below, the basestations may be a master node (MN) and a secondary node (SN).

In FIG. 3, the basestation can be divided into two physical entities named Centralized Unit (“CU”) and Distributed Unit (“DU”). Generally, the CU may provide support for the higher layers of the protocol stack such as SDAP, PDCP and RRC while the DU provides support for the lower layers of the protocol stack such as RLC, MAC and Physical layer. The CU may include operations for a transfer of user data, mobility control, radio access network sharing, session management, etc., except those functions allocated exclusively to the DU. The DU(s) are logical node(s) with a subset of the basestation functions, and may be controlled by the CU. The CU may be a logical node hosting RRC, SDAP and PDCP protocols of the basestation or RRC and PDCP protocols of the basestation that controls the operation of one or more DUs. The DU may be a logical node hosting RLC, MAC and PHY layers of the basestation, and its operation may be at least partly controlled by the CU. A single DU may support one or multiple cells. However, each cell is only supported by a single DU. Each basestation may support many cells.

FIG. 4 shows a network architecture with a master node (MN) and a secondary node (SN). The master node (MN) may control, while the secondary node (SN) provides supplemental data capacity. Connections are shown to the UE, with a connection between the MN and SN. MR-DC configurations may include EN-DC (E-UTRA—NR Dual Connectivity), NR-DC (New Radio Dual Connectivity), NGEN-DC (NG-RAN—E-UTRA Dual Connectivity) and NE-DC (NR—E-UTRA Dual Connectivity). E-UTRAN may support MR-DC via E-UTRA-NR Dual Connectivity (EN-DC). The UE is connected to one basestation (e.g. eNB) that acts as the MN and one basestation (e.g. en-gNB) that acts as the SN. In one embodiment, the eNB is connected to the EPC via the S1 interface and to the en-gNB via the X2 interface. In some embodiments, the en-gNB may be connected to the EPC via the S1-U interface and other en-gNBs via the X2-U interface. NG-RAN supports NG-RAN E-UTRA-NR Dual Connectivity (NGEN-DC). The UE is connected to one basestation (e.g. ng-eNB) that is the MN and one basestation (e.g. gNB) that is the SN. In some embodiments, the ng-eNB is connected to the network and the gNB is connected to the ng-eNB via the Xn interface.

As further described, a measurement gap may be modified based on communications between the MN, SN and user equipment (UE). A measurement gap is a period for the UE to perform measurements at different frequencies. During the gap, there may be no communication and the UE may turn off radios. The UE may measure the neighboring cells signal and/or other carrier components. The measurements may be performed with the same module as used for communication, so there may be a measurement gap. The UE may measure the neighbor signal transmitting on the same frequency while simultaneously transmitting and receiving data from the serving cell. While for measuring cell operating at different frequency (e.g. Inter frequency Neighbors) and Other RAT (LTE is other RAT for 5G NR), the UE may suspended communication (Tx/Rx) with the serving cell and needs to tune the communication module to configured frequencies (e.g. configured Meas Objects) and resume connection with serving cell after the gap, which is the time duration during which the UE suspends communication with a serving cell to measure inter frequency neighbor or other RAT neighbor.

Depending on the UE capability to support independent FR (frequency range) measurement and network preference, there may be two types of measurement gaps. One is per-UE and another is per-FR. In per-FR gap, two independent gap patterns (i.e. FR1 gap and FR2 gap) are defined for FR1 and FR2 respectively. Per-UE gap applies to both FR1 (E-UTRA and NR) and FR2 (NR) frequencies. Frequency range (FR) FR1 is frequency band gap where network stops communication with FR1 cells but still keeps communication with other cells (e.g. FR2). FR2 is frequency band gap where network stops communication with FR2 cells but still keeps communication with other cells (e.g. FR1). In particular, measurement gaps may be periods that the UE may use to perform measurements.

In new radio (NR) or 5G, there may be at least three different configurations (Meas Gap). The first configuration is gapFR1, which is a gap configuration applied to FR1. A second configuration is gapFR2, which is a configuration applied to FR2. Similar to gapFR1, gapFR2 may not be configured together with gapUE. A third configuration is a gapUE. If gapUE is configured, then neither gapFR1 nor gapFR2 can be configured. With this meas gap configuration, UE can measure FR1, FR2 and non NR RAT.

In the MN/SN example, the MN and the SN may coordinate and interact for the measurement and measurement gap configuration. If per-UE gap is used, the MN may decide the gap pattern and the gap sharing configuration. If per-FR gap is used, in EN-DC and NGEN-DC, the MN may decide the FR1 gap pattern and the gap sharing configuration for FR1, while the SN decides the FR2 gap pattern and the related gap sharing configuration for FR2. In NE-DC and NR-DC, the MN may decide both the FR1 and FR2 gap patterns and the gap sharing configurations. In EN-DC and NGEN-DC, the measurement gap configuration from the MN to the UE may indicate if the configuration from the MN is a per-UE gap or an FR1 gap configuration. The MN may indicate the configured per-UE or FR1 measurement gap pattern and the gap purpose (per-UE or per-FR1) to the SN. Measurement gap configuration assistance information may be exchanged between the MN and the SN. In the example of per-UE gap, the SN indicates to the MN the list of SN configured frequencies in FR1 and FR2 measured by the UE. For the per-FR gap example, the SN indicates to the MN the list of SN configured frequencies in FR1 measured by the UE and the MN indicates to the SN the list of MN configured frequencies in FR2 measured by the UE. In NE-DC, the MN may indicate the configured per-UE or FR1 measurement gap pattern to the SN. The SN may provide a gap request to the MN, without indicating any list of frequencies. In NR-DC, the MN may indicate the configured per-UE, FR1 or FR2 measurement gap pattern and the gap purpose to the SN. The SN may indicate to the MN the list of SN configured frequencies in FR1 and FR2 measured by the UE. The MN/SN coordination in MR-DC is further shown in Table 1 below.

TABLE 1
MN/SN Coordination in MR-DC

| MR- | Gap | MN -> SN (via CG- | SN -> MN (via CG- |
|---|---|---|---|
| DC | decision | ConfigInfo) | Config) |
| | | measuredFrequenciesMN | needForGaps |
| | | measGapConfig | measuredFrequenciesSN |
| | | gapPurpose | |
| | | measGapConfigFR2 | |
| EN-DC | MN: | For per-UE or FR1 gap: | For per-UE gap: |
| and | per-UE, | the configured per-UE or FR1 | the list of SN configured |
| NGEN- | FR1 | measurement gap pattern and the | frequencies in FR1 and FR2 |
| DC | SN: | gap purpose (per-UE or per-FR1) | For FR1 gap: |
| | FR2 | For FR2 gap: | the list of SN configured |
| | | the list of MN configured | frequencies in FR1 |
| | | frequencies in FR2 | |
| NE-DC | MN: | the configured per-UE or FR1 | a gap request to the MN, |
| | per-UE, | measurement gap pattern and the | without indicating any list of |
| | FR1, FR2 | gap purpose | frequencies |
| | | | (i.e. needForGaps) |
| NR-DC | MN: | the configured per-UE, FR1 or | the list of SN configured |
| | per-UE, | FR2 measurement gap pattern | frequencies in FR1 and FR2 |
| | FR1, FR2 | and the gap purpose | |

### Measurement Gap Enhancement (MGE)

Measurement gap enhancement (MGE) may be utilized. The MGE mechanism may include concurrent gap, pre-configured gap, network controlled small gap (NCSG), etc. In MR-DC, there may be two alternatives: 1) only NR Node supports MGE; or 2) both NR and LTE node support MGE. In alternative one, the LTE node only supports the legacy measurement gap. In examples of (NG)EN-DC and NE-DC, only the NR node can configure MGE (e.g. concurrent gap, pre-configured gap) while the LTE node can only configure or use the legacy gap. For NR-DC, both MN and SN may support MGE. For (NG)EN-DC, the SN may decide whether FR2 gap is needed, whether the concurrent gap is to be configured, and/or how many FR2 gap to be configured. For NE-DC, the MN may decide whether the concurrent gap is to be configured. When per-UE or FR1 gap is configured, it may include one legacy per-UE gap or legacy FR1 gap if the gap is requested for frequencies configured by LTE node. In alternative two, both NR and LTE nodes support MGE.

### Gap Type/Purpose

The gap is a period that a user equipment (UE) uses to perform measurements or operations with a dedicated use case. The use case may include at least one of the following: Positioning Reference Signaling (PRS) measurement, Multi-Universal Subscriber Identity Module (MUSIM), Non-Terrestrial Network (NTN) measurement, Synchronization Signal Block (SSB) measurement, Channel State Information Reference Signaling (CSI-RS) measurement, or E-UTRAN measurement. The allowed gap type or gap purpose or gap pattern may be communicated. In some examples, the gap type/purpose/pattern may include perUE, perFR1, perFR2, concurrent gap, pre-configured gap, network controlled small gap (NCSG), PRS gap, MUSIM gap, NTN gap, etc. The requested gap type/purpose/pattern may be a combination of one or more gap types/purposes/patterns. For example, there may be a concurrent gap combined with perUE. In another example, a pre-configured gap may be combined with perUE. In another example, NCSG may be combined with perUE. The measurement gap type and/or measurement gap purpose/pattern may be combined and/or communicated for more efficient communication regarding the measurement gap in the MN/SN embodiment.

The requested gap type/purpose/pattern may be indicated via one or more indication. For example, there may be an indication for one gap type/purpose/pattern (e.g. per UE, perFR1, per FR2). In another example, there may be an indication for another gap type/purpose/pattern (e.g. concurrent gap, pre-configured gap, NCSG, etc.). The indication may be transferred from the MN to the SN. In another example, the indication may be transferred from the SN to the MN. The indication (e.g. GapType) may be included as one information element (IE) in a Xn or X2 message (e.g. SN addition request message, SN modification request message or SN modification required message). The indication may be included in a inter-node RRC message, e.g. CG-ConfigInfo or CG-Config message. The RRC message is included as one information element in a Xn/X2 message (e.g. SN addition request message, SN modification request message or SN modification required message)

### Concurrent Gap

Concurrent gap is one type of a gap and is further described below. There may be multiple concurrent and independent multiple gap patterns. Multiple gap configurations may correspond with UE capability. There may be a mandatory association between gap and dedicated use cases (e.g., PRS, SSB, CSI-RS, EUTRA) by indicting a gap ID in the measurement objective or measurement gap (MG) configuration (e.g. for PRS). UE's measurement behavior may be well-defined, because the UE may be required to perform the measurement associated to the gap during that gap occasion. There may be a maximum supported concurrent gap pattern for per-FR gap incapable/capable UEs. For per-FR gap incapable UE, there may be up to two concurrent gap patterns that can be configured. For per-FR gap capable UE, there may be up to three concurrent gap patterns can be configured (e.g. up to two gaps in one FR).

TABLE 2
Gap combination examples.
Combinations of different gap types for per-FR gap capable UE

| | # of simultaneous MG | | | |
|---|---|---|---|---|
| Index | Per-FR1 | Per-FR2 | Per-UE | RAN4 conclusion |
| 0 | 2 | 1 | 0 | Supported |
| 1 | 1 | 2 | 0 | Supported |
| 2 | 0 | 0 | 2 | Supported |
| 3 | 1 | 0 | 1 | Supported when per- |
| 4 | 0 | 1 | 1 | UE gap is associated to |
| 5 | 1 | 1 | 1 | PRS measurement |
| 6 | 0 | 0 | 1 | Supported |
| 7 | 1 | 1 | 0 | Supported |
| 8 | 1 | 0 | 0 | Supported |
| 9 | 0 | 1 | 0 | Supported |
| 10 | 2 | 0 | 0 | Supported |
| 11 | 0 | 2 | 0 | Supported |

There may be a proximity condition of colliding gap occasions. Upon colliding, UE drops the gap with a lower priority level which is configured by network. Data scheduling may be resumed on dropped gap occasion. The corresponding UE requirements regarding gap interruption, measurement delay, and L1 measurement impact may be updated.

As a first issue, the communication related to gap configuration/generation may need to know which node (MN or SN) decides to configure/use the concurrent gap. As another issue, there is a decision as to deciding/generating the gap association. There is a determination as to which node (MN or SN) decides the requested or allowed gap or gap combination information, which may include the number of gap patterns or gap combinations, whether the concurrent gap is required, whether the legacy gap (e.g. indicated by GagConfig IE) and/or R17 gap (e.g. indicated by GagConfig-r17 IE) is required, the requested or allowed gap type/purpose/pattern, gap priority, etc. The gap association may associate the measurement object with the measurement gap which is used for SSB or CSI-RS measuring identified by the associated measurement object. The gap association may associate the dedicated use case with the measurement gap. The use case may include at least one of the following: positioning/PRS gap, Multi-Universal Subscriber Identity Module (MUSIM) gap, Non-Terrestrial Network (NTN) gap, gap for SSB measurement, gap for CSI-RS measurement, gap for E-UTRAN measurement, etc.

FIG. 5 shows an example of a process with a concurrent gap embodiment. In block 502, either the MN or the SN decides to configure the concurrent gap. In one embodiment, it may be the MN in all MR-DC embodiments. Specifically, the MN informs the SN that the concurrent gap is requested/allowed implicitly (e.g. by sending multiple per-UE or FR1 gaps to the SN) or explicitly (e.g. by sending an indication to indicate the concurrent gap is requested/allowed). In another example, the SN may request to configure the concurrent FR2 gap and send the request indication to the MN (e.g. the SN may want to configure 2 FR2 gaps in (NG)EN-DC), then the SN can send a concurrent gap request indication to the MN. The MN may decide to accept or reject the request from the SN. In another embodiment, the configuration of the concurrent gap may be decided by the SN, e.g. in (NG)EN-DC examples. The SN decides whether to configure the concurrent FR2 gap and sends an indication to the MN to indicate whether the concurrent gap is configured or not. The indication may include: 1) an indicator that the concurrent gap is requested/allowed; 2) a requested/allowed gap combination; or 3) a requested/allowed gap number.

In block 504, either the MN or the SN decides gap combination information. In one embodiment, e.g. in NR-DC and NE-DC cases, it may be the MN that decides. In another embodiment, e.g. in (NG)EN-DC, there may be a number of embodiments for either the MN or the SN. When the MN decides, there may be at least three options: 1) the MN decides the gap or gap combination to be used, and sends the gap or gap combination information (e.g. the gap combination, the requested FR2 gap number) to the SN; 2) the MN decides the allowed gap or gap combination, and sends the allowed/suggested gap or gap combination (e.g. a list of allowed gap combinations, the maximum number of FR2 gap) to the SN, which can select one of them to configure FR2 gap; or 3) the MN sends one or more allowed gap or gap combination information to the SN and if the SN wants others, the SN can send the requested gap or gap combination (e.g. the requested FR2 gap number, the requested gap combination) to the MN. Likewise, when the SN decides, there may be at least three options: 1) the SN decides the gap or gap combination to be used, and sends the gap or gap combination information (e.g. the gap combination, the requested/allowed per UE gap number and/or FR1 gap number) to the MN; 2) the SN decides the allowed gap or gap combination, and sends the allowed/suggested gap or gap combination information (e.g. a list of allowed gap combinations, the maximum number of per-UE gap and/or FR1 gap) to the MN, which can select one of them to configure per-UE gap and/or FR1 gap; or 3) the SN sends one or more allowed gap or gap combination information to the MN and if the MN wants others, the MN can send the requested gap or gap combination information (e.g. the requested number of per-UE gap and/or FR1 gap, the requested gap combination) to the SN.

The gap information or gap combination information may vary in different embodiments. The gap combination information may include the requested/allowed number of gap patterns. The gap patterns may be indicated by a total or maximum number for gap patterns allowed to be configured by the SN or the MN, or for each gap type, a requested or maximum number of gap patterns allowed to be configured by SN or the MN. The gap combination information may include the requested/allowed gap combination, which may be indicated by a bit string/bitmap, each position in the bitmap indicates whether the corresponding gap combination in the RAN4-defined table (see Table 2) is requested or not (e.g. value 1 indicates the corresponding gap combination is requested/allowed) or one or a list of gap combination index that is allowed to be used/configured by the SN or the MN (e.g. value 1 indicates the first gap combination in the RAN4-defined table, such as Table 2), and value 2 indicates the second gap combination in the RAN4-defined table (i.e. Table 2). The gap combination information may include an indication to indicate whether the legacy gap (i.e. GagConfig, without gap ID) and/or the new gap (i.e. GapConfig-r17, with gap ID) is requested/allowed to be configured. The gap combination information may include the gap ID or gap ID range to be used for the gap configured/generated by the SN (e.g. for FR2 gap in (NG)EN-DC, to avoid the gap ID conflict). The gap combination information may include the gap ID or gap ID range to be used for the gap configured/generated by the MN (e.g. for perUE gap or FR1 gap in (NG)EN-DC, to avoid the gap ID conflict). The gap combination information may include the gap priority information to be used for the gap configured/generated by the SN or the MN. The gap priority information may include one or a list of gap priority for the gap used for different features/uses cases (e.g. positioning/PRS gap, MUSIM gap, NTN gap, gap for SSB measurement, gap for CSI-RS measurement, gap for E-UTRAN measurement, etc.). In some embodiments, a list of gap feature/use case (each one is linked with a gap priority value), where the priority value for each gap is indicated as an integer (e.g. value 1 indicates highest priority, value 2 indicates second level priority, etc.). The gap with highest priority may be used or the gap priority may be associated with gap features/use cases. The gap priority indication or indicator may be used to indicate which gap has high priority. The gap priority may also include one or a list of gap priority for the gap for associated frequencies or measObject measurement. For example, a list of SSB/CSI-RS frequencies may be linked with a gap priority value. The priority value for each gap may be indicated as an integer (e.g. value 1 indicates highest priority, value 2 indicates second level priority, etc.). Another example includes the measured frequencies priority information may be indicated as a list of frequencies or measObjects ranked from high priority to low priority. The receiving node may use this information to generate the gap priority for a gap that is used to measure the corresponding frequencies or measObjects. This may be similar to a gap priority for frequencies, where there is a priority for different frequency values.

In block 506, either the MN or the SN generates gap association based on the gap combination information. In some embodiments, e.g. in NE-DC and NR-DC, the MN may generate the per-UE/FR1/FR2 gap. The MN may decide which gap combination is to be used and the gap association between gap and dedicated use cases (e.g., PRS, SSB, CSI-RS, EUTRA). In one embodiment, the MN decides the gap association for all configured measurement objects (MOs). In another embodiment, the MN decides the gap association for MN configured MOs, while the SN decides the gap association for SN configured MOs.

In the embodiment, where the MN decides the gap association for all configured measurement objects (MOs), the MN may send the gap association for SN configured frequencies or measurement objects to the SN, and then the SN updates the measurement object configuration generated/configured by the SN. More specifically, the SN sends a list of SN configured frequencies in FR1 and FR2 (e.g. for NR-DC) and/or a gap request (e.g. for NE-DC), to the MN. The MN sends the MN generated gap configuration or gap configuration list (e.g. including the configured per-UE, FR1 or FR2 measurement gap pattern, the gap purpose), and/or the gap association for SN configured frequencies (e.g. a list of gap ID, each gap ID links with a list of SSB/CSI-RS frequencies to be associated with the indicated gap), to the SN. The SN may re-configure SN configured measurement objects (e.g. including the associated gap ID in the MeasObject, based on the received gap association). The SN may send the updated measurement objects configuration to the UE via the MN or via SRB3.

In another example in the embodiment where the MN decides the gap association for all configured measurement objects (MOs), the SN sends the measurement object configuration to the MN, and the MN updates the SN measurement object configuration. The SN sends the SN configured measurement objects to the MN. The MN re-configures the SN configured measurement objects (e.g. to include the associated gap ID in the MeasObject). The MN may send the updated SN measurement objects configuration to the SN and/or the UE.

In the embodiment where the MN decides the gap association for MN configured MOs, while the SN decides the gap association for SN configured MOs. The SN sends a list of SN configured frequencies in FR1 and FR2 (e.g. for NR-DC) and/or a gap request (e.g. for NE-DC), to the MN. From the MN to the SN, the MN generated gap configuration or gap configuration list (e.g. including the configured per-UE, FR1 or FR2 measurement gap pattern, the gap purpose) is provided. The SN decides the gap association for SN configured measurement objects (according to the received measurement gap pattern) and re-configures measurement objects (e.g. to include the associated gap ID in the MeasObject). The SN may send the updated measurement objects configuration to the UE via the MN or via SRB3.

In some embodiments, e.g. in (NG)EN-DC, the MN may generate per-UE gap and FR1 gap, while the SN generates per-FR2 gap. Both MN and SN may generate or decide the gap association as in block 506. In one embodiment, for per-UE gap or FR1 gap, the MN decides the gap association for all configured MOs or FR1 MOs, but for the FR2 gap, the SN decides the gap association for all configured FR2 MOs. This embodiment may include the MN sending the gap association for SN configured frequencies to the SN, and then the SN updates the measurement object configuration. The message from SN to MN may include a list of SN configured frequencies in FR1 and FR2 (for per-UE gap), or frequencies in FR1 (for FR1 gap). The message from MN to SN may include the MN generated gap configuration or gap configuration list (e.g. including the configured per-UE, or FR1 measurement gap pattern, the gap purpose), and/or the gap association for SN configured frequencies (e.g. a list of gap ID, each gap ID links with a list of SSB/CSI-RS frequencies to be associated with the indicated gap). The SN re-configures SN configured measurement objects (e.g. to include the associated gap ID in the MeasObject, based on the received gap association). The SN may send the updated measurement objects configuration to the UE via the MN or via SRB3.

In another example, the SN sends the measurement object configuration to the MN, and the MN updates the SN measurement object configuration. The message from SN to MN may include the SN configured measurement objects. The MN may re-configure the SN configured measurement objects (e.g. to include the associated gap ID in the MeasObject). The MN may send the updated SN measurement objects to the SN and/or the UE.

In another embodiment for the FR2 gap, the SN sends the gap association for MN configured frequencies to the MN, and then the MN updates the measurement object configuration. The message from MN to SN may include a list of MN configured frequencies in FR2. The message from SN to MN may include the SN generated gap configuration or gap configuration list (e.g. including the configured FR2 measurement gap pattern), and/or the gap association for MN configured frequencies (e.g. a list of gap ID, each gap ID links with a list of SSB/CSI-RS frequencies to be associated with the indicated gap). The MN may re-configure MN configured FR2 measurement objects (e.g. to include the associated gap ID in the MeasObject) based on the received gap association. The MN may send the updated measurement objects configuration to the UE.

In another example, the SN sends the measurement object configuration to the SN, and the SN updates the MN measurement object configuration. The message from MN to SN may include the MN configured measurement objects. The SN may re-configure the MN configured measurement objects (e.g. including the associated gap ID in the MeasObject). The SN may send the updated MN measurement objects to the MN.

In another embodiment for each gap type, the MN decides the gap association for MN configured MOs, the SN decides the gap association for SN configured MOs. This may include an example for per-UE gap or FR1 gap. The message from SN to MN may include a list of SN configured frequencies in FR1 and FR2, or frequencies in FR1. The message from MN to SN may include the MN generated gap configuration or gap configuration list (e.g. including the configured per-UE, or FR1 measurement gap pattern, the gap purpose). The SN may decide the gap association for SN configured measurement objects (e.g. according to the received measurement gap pattern) and re-configure measurement objects (e.g. to include the associated gap ID in the MeasObject). The SN may send the updated measurement objects configuration to the UE via the MN or via SRB3.

In another example for FR2 gap, the message from MN to SN may include a list of MN configured frequencies in FR2. The message from SN to MN may include the SN generated gap configuration or gap configuration list (e.g. including the configured FR2 measurement gap pattern). The MN may decide the gap association for MN configured FR2 measurement objects (according to the received measurement gap pattern) and re-configure measurement objects (e.g. to include the associated gap ID in the MeasObject). The MN may send the updated measurement objects configuration to the UE and/or the SN.

### Gap Association

The gap association may be indicated as: 1) a list of gap ID, each gap ID links with one or a list of MeasObjec IDs to be associated with the corresponding gap; 2) a list of gap ID, each gap ID links with one or a list of SSB/CSI-RS frequencies to be associated with the corresponding gap; or 3) a list of MeasObject IDs, each one links with one or more gap IDs to be associated with the corresponding MeasObject. For example, for E-UTRAN MeasObject, one MeasObject is associated with one gap ID; for NR MeasObject, one MeasObject is associated with one or more gap ID (e.g. one gap ID associated with SSB measurement, the other gap ID associated with CSI-RS measurement). A fourth example may include a list of SSB/CSI-RS frequencies, where each one links with one or more gap IDs to be associated with the corresponding frequencies. A fifth example may include a list of gap ID, each gap ID links with one or more uses cases to be associated with the corresponding gap. A sixth example may include a list of uses cases, each use case links with one or a list of gap IDs.

Examples of signaling structure for the gap or gap combination are shown in the following table:

TABLE 3
Examples of signaling structure for the gap or gap combination.

| | | | | | | |
|---|---|---|---|---|---|---|
| | | | IE type and | Semantics | | Assigned |
| IE/Group Name | Presence | Range | reference | description | Criticality | Criticality |

| | | | |
|---|---|---|---|
| Gap | O | BIT STRING | Indicates the |
| Combination | | (SIZE(12)) | allowed/requested |
| Information | | | gap combination |
| | | | as defined in |
| | | | Table 9.1.8-1 in |
| | | | TS 38.133 [38]. |
| Gap Config | O | ENUMERATED | Indicates whether |
| Type | | (GapConfig, | the GapConfig, |
| | | GapConfig-r17, | GapConfig-r17, or |
| | | both, . . . ) | both is used for |
| | | | the gap |
| | | | configuration. |

Examples of signaling structure for the gap association information are shown in the following table:

TABLE 4
Examples of signaling structure for the gap association information.

| | | | IE type and | Semantics | | Assigned |
|---|---|---|---|---|---|---|
| IE/Group Name | Presence | Range | reference | description | Criticality | Criticality |
| Gap Association | | 0 . . . 1 | | | YES | ignore |
| Information List | | | | | | |
| >Gap Association | | 1 . . . | | | EACH | ignore |
| Item IEs | | <maxnoofGaps> | | | | |
| >>Measurement | M | | INTEGER | Gap Identifier | — | |
| Gap ID | | | (1 . . . 8) | | | |
| >>Gap Mapped | | 1 . . . | | | — | |
| to MeasObject | | <maxnoofMeasObjects> | | | | |
| Item | | | | | | |
| >>>MeasObject | M | | INTEGER | Measurement | — | |
| ID | | | (1 . . . 64) | Object | | |
| | | | | Identifier | | |

Additional examples of signaling structure for the gap association information are shown in the following table:

TABLE 5
Additional examples of signaling structure
for the gap association information.

| Range bound | Explanation |
|---|---|
| maxnoofGaps | Maximum no. of Gaps allowed towards |
| | one UE, the maximum value is 8. |
| maxnoofMeasObjects | Maximum no. of measurement objects allowed |
| | towards one UE, the maximum value is 64. |

Additional examples of signaling structure for the gap association information are shown in the following table:

TABLE 6
Additional examples of signaling structure for the gap association information.

| | | | IE type and | Semantics | | Assigned |
|---|---|---|---|---|---|---|
| IE/Group Name | Presence | Range | reference | description | Criticality | Criticality |
| Gap Association | | 0 . . . 1 | | | YES | ignore |
| Information List | | | | | | |
| >Gap Association | | 1 . . . | | | EACH | ignore |
| Item IEs | | <maxnoofMeasObjects> | | | | |
| >>MeasObject ID | M | | INTEGER | Measurement | — | |
| | | | (1 . . . 64) | Object | | |
| | | | | Identifier | | |
| >>CHOICE | M | | | | — | |
| MeasObject Mapped | | | | | | |
| to Gap | | | | | | |
| >>>MeasObject | M | | | | — | |
| Mapped to Gap | | | | | | |
| >>>>Associated | O | | INTEGER | Gap Identifier | — | |
| Measurement SSB | | | (1 . . . 8) | | | |
| Gap ID | | | | | | |
| >>>>Associated | O | | INTEGER | Gap Identifier | — | |
| Measurement CSI- | | | (1 . . . 8) | | | |
| RS Gap ID | | | | | | |
| >>>E-UTRAN | M | | | | — | |
| MeasObject Mapped | | | | | | |
| to Gap | | | | | | |
| >>>>Associated | M | | INTEGER | Gap Identifier | — | |
| Measurement Gap | | | (1 . . . 8) | | | |
| ID | | | | | | |

Additional examples of signaling structure for the gap association information are shown in the following table:

TABLE 7
Additional examples of signaling structure
for the gap association information.

| Range bound | Explanation |
|---|---|
| maxnoofGaps | Maximum no. of Gaps allowed towards |
| | one UE, the maximum value is 8. |
| maxnoofMeasObjects | Maximum no. of measurement objects allowed |
| | towards one UE, the maximum value is 64. |

### Pre-Configured

In another gap type, the measurement gap may be pre-configured by the network. There may be a pre-configured MG pattern(s). In one embodiment, it may be network controlled, or in another embodiment, it may be a user equipment (UE) autonomous mechanism. It may include multiple activation/de-activation mechanisms and corresponding UE capabilities to support these mechanisms. For a network-controlled mechanism, in which UE follows the per-bandwidth part (BWP) indications in active serving cell and per-cell indications in deactivated serving cells to decide the ON/OFF status of the pre-configured MG.

For the UE autonomous mechanism, the UE may follow defined rules (e.g. in TS38.133) to decide the ON/OFF status of the pre-configured MG. If MG is not needed for all measurements, the pre-configured gap may be deactivated (OFF). Otherwise, the pre-configured gap may be activated (ON). Events that may trigger the UE to re-check the ON/OFF status includes
DCI/Timer based BWP switching;
activation/de-activation of SCell(s);
addition/removal of any measurement object(s);
addition/release/change of a Scell under CA;
BWP switching by RRC; or
initiation of LocationMeasurementIndication.

There may be an additional delay for pre-configured MG activation/deactivation which may be five milliseconds (ms) on top on the legacy procedure delay that may trigger pre-configured MG status change. There may be an update of the corresponding UE requirements regarding gap interruption, measurement delay, and/or L1 measurement impact.

For the pre-configured gap, there may be a first issue for determining which node decides to configure/use the pre-configured gap. In one embodiment, the MN decides whether to use the pre-configured gap and/or which type of pre-configured gap mechanism is to be used. In that embodiment, the MN may send one or more indications (e.g. pre-configuredGap indicator) to the SN to indicate whether the pre-configured gap is requested/allowed, and/or which type of pre-configured gap mechanism is to be used (e.g. network controlled mechanism, UE autonomous mechanism). In that embodiment, the SN may configure/use the measurement gap according to the indication from the MN. In that example, if the NW-controlled pre-configured gap is used, the SN decides and includes the pre-configured gap status for each BWP and/or deactivated SCell configured by the SN. In that embodiment, the MN may decide whether the pre-configured gap is requested/allowed (e.g. for all configured gap pattern type) and sends an indication to the SN. In that example, if the pre-configured gap is requested/allowed, the SN decides which type of mechanism is to be used for SN configured gap (e.g. for FR2 gap in (NG)EN-DC) and/or SN configured BWP/SCell.

In another embodiment for the pre-configured gap for determining which node decides to configure/use the pre-configured gap, the MN may decide whether to use the pre-configured gap and/or which type of pre-configured gap mechanism is to be used for MN configured gap and/or MN configured BWP/SCell. Further, the SN may decide whether to use the pre-configured gap and/or which type of mechanism is to be used for SN configured gap (e.g. FR2 gap in (NG)EN-DC) and/or SN configured BWP/SCell.

The pre-configured gap status may be indicated as a bit string, so the MN/SN may need to know all configured gap IDs. When the network controlled mechanism is applied to the pre-configured gap, each node can decide the pre-configured gap status for each BWP and/or deactivated SCell configured by itself, considering that the BWP/SCell configuration is transparent to the peer node.

In one embodiment, the MN sends the configured measurement gap pattern(s) and/or gap ID(s) to the SN. The SN decides and includes the pre-configured gap status for each BWP and/or each deactivated SCell configured by the SN. In another embodiment, e.g. for FR2 gap in (NG)EN-DC, the SN sends the configured measurement gap pattern(s) and/or the gap ID(s) to the MN. The MN decides and includes the pre-configured gap status for each BWP and/or each deactivated SCell configured by the MN.

### Network Controlled Small Gap (NCSG)

The NCSG and/or NeedforGap mechanism is a UE capability reporting based on RRC complete message, e.g. RRCReconfigurationComplete and RRCResumeComplete messages. The UE can indicate the measurement gap requirement information of the UE for NR/E-UTRA target bands to the NW, e.g. the UE can report whether to support ‘gap’, ‘no-gap, ‘ncsg’, or ‘nogap-noncsg’ for each target band to be measured.

When the SN generates/decides the measurement gap (e.g. FR2 gap in (NG)EN-DC), the MN may transfer the NeedForGap and/or NCSG information to the SN via Xn/X2 message, to help the SN decide the measurement gap. The NeedForGap and/or NCSG information is to indicate whether measurement gap or NCSG is required for the UE to perform measurements on a target band. The UE sends the information to the MN via the RRC Reconfiguration/Resume Complete message.

There may twenty-four NCSG patterns with visible interruption (VIL1 and VIL2, which are 1 ms for FR1 and 0.75 ms for FR2) before and after the measurement length (ML). The UE may be expected to continue download (DL) reception or upload (UL) transmission with serving cells during measurement length. The UE may have behaviors for the cases when UE reports different capabilities on ‘no-gap-no-interruption’, ‘ncsg’ or ‘gap’ but with a different a network configuration (NCSG or legacy MG) which may differ from the UE's reported capability. There may be a synchronization indication between the target NR band to be measured and a reference serving cell of UE to reduce the OFDM symbols restricted from data scheduling, when UE is incapable for simultaneous transmission/reception (Tx/Rx) or independent beamforming (FR2-specific). There may be a corresponding UE requirement regarding gap interruption, scheduling restriction and measurement delay as well as an update for the impact to L1 measurements.

The following table illustrates examples for signaling structure on NeedForGap and/or NCSG information:

TABLE 8
Example signaling structure on NeedForGap and/or NCSG information

| | | | | | | |
|---|---|---|---|---|---|---|
| | | | IE type and | Semantics | | Assigned |
| IE/Group Name | Presence | Range | reference | description | Criticality | Criticality |

| | | | |
|---|---|---|---|
| NeedForGapNCSG- | O | OCTET | NeedForGapNCSG- |
| InfoNR | | STRING | InfoNR, as defined in |
| | | | TS 38.331 [8]. |
| NeedForGapNCSG- | O | OCTET | NeedForGapNCSG- |
| InfoEUTRA | | STRING | InfoEUTRA, as |
| | | | defined in TS 38.331 |
| | | | [8]. |
| NeedForGapsInfoNR | O | OCTET | NeedForGapsInfoNR, |
| | | STRING | as defined in TS |
| | | | 38.331 [8]. |

### Gap Information Transfer

The gap information, which may also be referred to as gap related information, may include gap combination information, gap association information, gap configuration/pattern/purpose, pre-configured gap indication, and/or NCSG/NeedforGap information, as mentioned above. The gap information may be transferred between the MN and the SN by at least one of the following options: 1) the gap information is included directly as information element(s) in a Xn/X2 message (e.g. SN addition request message, SN addition request acknowledge message, SN modification request message, SN modification request acknowledge message, SN modification required message or SN modification confirm message); or 2) gap information is included in a inter-node RRC message (e.g. CG-ConfigInfo or CG-Config message). The RRC message is included as one information element in a Xn/X2 message (e.g. SN addition request message, SN addition request acknowledge message, SN modification request message, SN modification request acknowledge message, SN modification required message, or SN modification confirm message).

The measurement gap configuration/pattern (e.g. including legacy measurement gap, concurrent gap, per-configured gap, etc.) may be transferred between the MN and the SN. An inter-node RRC message from the MN to the SN (e.g. CG-ConfigInfo message), may include only the legacy measurement gap configuration (e.g. measGapConfig, measGapConfigFR2, which refer to GapConfig (legacy IE)). To transfer the MGE configuration to the SN, a separate gap indication (e.g. measGapConfig-xy, measGapConfigFR2-xy IEs, which can refer to GapConfig-r17 IE) or a separate gap list (e.g. measGapConfigList-xy IE, which can refer to gapToAddModList-r17 IE) may be utilized. This indication may be used to transfer the new gap configuration from the MN to the SN. In the inter-node RRC message from the SN to the MN (e.g. CG-Config message), a gap indication (e.g. measGapConfigFR2-xy IEs, which can refer to GapConfig-r17 IE) or a gap list (e.g. measGapConfigList-xy IE, which can refer to gapToAddModList-r17 IE) may be used to transfer the gap configuration from the SN to the MN. Examples of ASN.1 signaling structure are shown below:

CG-ConfigInfo message

MeasConfigMN ::= SEQUENCE {

| | |
|---|---|
| measuredFrequenciesMN | SEQUENCE (SIZE |
| (1..maxMeasFreqsMN)) OF NR-FreqInfo | OPTIONAL, |
| measGapConfig | SetupRelease { GapConfig } |

OPTIONAL,

| | |
|---|---|
| gapPurpose | ENUMERATED {perUE, perFR1} |

```
OPTIONAL,
    ...,
    [[
```

| | |
|---|---|
| measGapConfigFR2 | SetupRelease { GapConfig } |

```
OPTIONAL
    ]]
    [[
```

| | |
|---|---|
| measGapConfigList-xy | SetupRelease { |
| GapToAddModList-r17 } | OPTIONAL |

```
    ]]
}
or
    [[
```

| | |
|---|---|
| measGapConfig-xy | SetupRelease { GapConfig-r17 |
| } | OPTIONAL, |
| gapPurpose-r17 | ENUMERATED {perUE, |
| perFR1} | OPTIONAL, |
| measGapConfigFR2-xy | SetupRelease { GapConfig- |
| r17 } | OPTIONAL |

```
    ]]
or
    [[
```

| | |
|---|---|
| measGapConfigToAddModList-xy | GapToAddModList- |
| r17 | OPTIONAL |

measGapConfigToReleaseList-xy

| | |
|---|---|
| GapToReleaseList-r17 | OPTIONAL |

]]

CG-Config message

| | |
|---|---|
| MeasConfigSN ::= | SEQUENCE { |
| measuredFrequenciesSN | SEQUENCE (SIZE |
| (1..maxMeasFreqsSN)) OF NR-FreqInfo | OPTIONAL, |

```
  ...
    [[
```

| | |
|---|---|
| measGapConfigFR2List-xy | SetupRelease { |
| GapToAddModList-r17 } | OPTIONAL |

```
    ]]
}
or
    [[
```

| | |
|---|---|
| measGapConfigFR2-xy | SetupRelease { GapConfig- |
| r17 } | OPTIONAL |

```
    ]]
or
    [[
  measGapConfigFR2ToAddModList-xy
```

| | |
|---|---|
| GapToAddModList-r17 | OPTIONAL |

measGapConfigFR2ToReleaseList-xy

| | |
|---|---|
| GapToReleaseList-r17 | OPTIONAL |

]]
}

FIG. 6 shows one embodiment of communications between a master node (MN) and a secondary node (SN). In block 602, the gap or gap combination assistance information is generated by the MN and is transmitted to the SN. The SN generates the gap related configuration based on the gap or gap combination assistance information in block 604. The gap related configuration may include the gap pattern configuration, the gap association information, and/or the gap ID information, etc. The generated gap related configuration is transmitted by the SN to the MN in block 606. The gap related configuration received by the MN is used to generate the gap association and/or update/re-configure the MN generated measurement configuration in block 608. In some embodiments, not all blocks in the figure are performed. In one example, block 602, 604 and 606 are performed. In another example, block 606 and 608 are performed.

FIG. 7 shows another embodiment of communications between a master node (MN) and a secondary node (SN). In block 702, the gap or gap combination assistance information is generated by the SN and is transmitted to the MN. The MN generates the gap related configuration based on the gap combination assistance information in block 704. The gap related configuration may include the gap pattern configuration, the gap association information, and/or the gap ID information, etc. The generated gap related configuration is transmitted by the MN to the SN in block 706. The gap related configuration received by the SN is used to generate the gap association and/or update/re-configure the MN generated measurement configuration in block 708. In some embodiments, not all blocks in the figure are performed. In one example, block 702, 704 and 706 are performed. In another example, block 706 and 708 are performed.

The examples shown in FIGS. 5-7 are for a gap type with concurrent gaps, pre-configured gaps and/or NCSG. The gap or gap combination assistance information may refer to the gap information or gap combination information, as mentioned above.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication comprising:
receiving, at a secondary node (SN) from a master node (MN), a gap assistance information;
generating, at the SN, gap related configuration based on the received gap assistance information; and
transmitting, from the SN to the MN, the gap related configuration.

2-5. (canceled)

6. The method of claim 1, wherein the gap related configuration comprises at least one of a gap pattern configuration, a gap identification (ID) information, or a gap association information; and wherein the gap assistance information comprises a period that a user equipment (UE) uses to perform measurements or operations with a dedicated use case.

7. (canceled)

8. The method of claim 1, wherein the gap assistance information comprises at least one of a requested or allowed gap type, a requested or allowed gap purpose, a requested or allowed gap pattern, a requested or allowed number of gap patterns, a requested or allowed gap combination information, a gap identification (ID), a gap ID range, or a gap priority information.

9. The method of claim 8, wherein the requested or allowed gap type comprises at least one of a concurrent gap, a pre-configured gap, or a network controlled small gap (NCSG).

10. The method of claim 8, wherein the requested or allowed gap purpose or gap pattern comprises at least one of a per frequency range (FR) 1 gap, a per FR2 gap or a per UE gap.

11. The method of claim 8, wherein the requested or allowed gap combination information comprises at least one of a bit string or a bitmap, each position in the bit string or the bitmap indicating whether the corresponding gap combination is requested or not indicating at least one gap combination index.

12. The method of claim 6, wherein the gap association information comprises at least one of one or a list of measurement gap being associated with a measurement object or a measurement frequency, or one or a list of measurement gap being associated with a dedicated use case.

13. The method of claim 1, wherein the gap assistance information comprises an indication configured to indicate whether a pre-configured gap is requested or allowed, or which type of pre-configured gap mechanism is to be used.

14. The method of claim 1, further comprising:
receiving, at the SN from the MN, a gap association information; and
updating, at the SN, a measurement configuration based on the received gap association information.

15. The method of claim 14, wherein the gap association information comprises at least one of a measurement gap being associated with a measurement object or a measurement frequency, or a measurement gap being associated with a dedicated use case.

16. The method of claim 15, wherein the gap association information is for a use case comprising at least one of Positioning Reference Signaling (PRS) measurement, Multi-Universal Subscriber Identity Module (MUSIM) operation, Non-Terrestrial Network (NTN) measurement, Synchronization Signal Block (SSB) measurement, Channel State Information Reference Signaling (CSI-RS) measurement, or E-UTRAN measurement.

17. The method of claim 14, wherein the gap association information comprises one or a list of gap ID, each gap ID links with a list of SSB or CSI-RS frequencies to be associated with a measurement gap, or each gap ID links with a dedicated use case.

18-19. (canceled)

20. The method of claim 14, wherein the gap association information comprises SN configured frequencies, and the updating comprises that the SN updates a measurement object configuration to associate a measurement object with a measurement gap.

21-23. (canceled)

24. A wireless communication apparatus comprising a processor and a memory, wherein the processor is configured to read code from the memory and implement a method recited in claim 1.

25. (canceled)

26. A method for wireless communication comprising:
receiving, at a master node (MN) from a secondary node (SN), a gap assistance information;
generating, at the MN, gap related configuration based on the received gap assistance information; and
transmitting, from the MN to the SN, the gap related configuration.

27. The method of claim 26, wherein the gap assistance information comprises an indication configured to indicate whether a pre-configured gap is requested or allowed, or which type of pre-configured gap mechanism is to be used.

28. The method of claim 26, further comprising:
receiving, at the MN from the SN, a gap association information; and
updating, at the MN, a measurement configuration based on the received gap association information.

29. The method of claim 28, wherein the gap association information comprises at least one of a measurement gap being associated with a measurement object or a measurement frequency, or a measurement gap being associated with a dedicated use case.

30. The method of claim 28, wherein the gap association information comprises MN configured frequencies, and the updating comprises that the MN updates a measurement object configuration to associate a measurement object with a measurement gap.

31. A wireless communication apparatus comprising a processor and a memory, wherein the processor is configured to read code from the memory and implement a method recited in claim 26.
